(19) United States
(12) Patent Application Publication
(10) Pub. No.: US 2010/0324704 A1
(43) Pub. Date: Dec. 23, 2010

(54) SOCIAL GRAPH PLAYLIST SERVICE

(75) Inventors: Shawn M. Murphy, Seattle, WA (US); Christopher B. Weare, Bellevue, WA (US); Christopher A. Evans, Sammamish, WA (US); Chad C. Gibson, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/486,543

(22) Filed: Jun. 17, 2009

(51) Int. Cl. G06F 17/00; G06F 3/048; G06Q 10/00; G06N 5/02; G06Q 99/00

(52) U.S. Cl. 700/94; 715/716; 705/10; 706/52; 705/319; 705/1.1

(57) ABSTRACT

A social graph playlist service is described. In embodiments, a social graph that associates a user and friends of the user is maintained. The social graph is based on parameters that define a social relationship between the user and the friends of the user. Interaction data that identifies recently played media assets at user devices that are utilized by the friends of the user can be received. A social graph playlist that is associated with the user can be generated by determining a next media asset for the playlist from the recently played media assets. The next media asset for the playlist can then be communicated to be played at a user device that is associated with the user.

### BACKGROUND

A recommendation from a friend to listen to a song, or to see a movie, can be an effective way for a person to discover new songs and movies. However, a person is not likely to receive recommendations from friends on a continuous basis. For instance, people may miss out listening to songs that their friends already listen to and enjoy simply because they do not discuss music with their friends on a consistent basis. Similarly, a person may enjoy listening to music played by friends when hanging out with their friends. However, a person is not likely to hang out with friends on a continuous basis, and might still miss out discovering new songs, movies, and other media that the person may enjoy.

### SUMMARY

This summary is provided to introduce simplified concepts of a social graph playlist service. The simplified concepts are further described below in the Detailed Description. This summary is not intended to identify essential features of the claimed subject matter, nor is it intended for use in determining the scope of the claimed subject matter.

A social graph playlist service is described. In embodiments, a social graph that associates a user and friends of the user is maintained. The social graph is based on parameters that define a social relationship between the user and the friends of the user. Interaction data that identifies recently played media assets at user devices that are utilized by the friends of the user is received. A social graph playlist that is associated with the user can be generated by determining a next media asset for the playlist from the recently played media assets. The next media asset for the playlist is then communicated to be played at a user device that is associated with the user. In various embodiments, the recently played media assets are digital music files of songs.

In various embodiments, the next media asset for the playlist is determined by assigning a prediction rating to each of the recently played media assets that indicates the likelihood that the user will like each of the recently played media assets. The prediction rating is based on stored interaction data associated with the user. Alternatively or in addition, the prediction rating is based on a user similarity rating determined from a similarity between stored interaction data associated with the user and stored interaction data associated with the friends of the user that are associated in the social graph.

In other embodiments, a rating of the next media asset is received from the user device associated with the user. The rating is then compiled with stored interaction data associated with the user. In other embodiments, additional interaction data that identifies currently playing media assets at the user devices that are utilized by the friends of the user is received. An additional next media asset for the social graph playlist associated with the user can then be determined from the recently played media assets and the currently playing media assets.

### BRIEF DESCRIPTION OF THE DRAWINGS

Embodiments of a social graph playlist service are described with reference to the following drawings. The same numbers are used throughout the drawings to reference like features and components:

FIG. 1 illustrates an example system in which embodiments of a social graph playlist service can be implemented.

FIG. 2 illustrates an example social graph playlist interface displayed at a user device.

FIG. 3 illustrates example method(s) for a social graph playlist service in accordance with one or more embodiments.

FIG. 4 illustrates example method(s) for a social graph playlist service in accordance with one or more embodiments.

FIG. 5 illustrates various components of an example device that can implement embodiments of a social graph playlist service.

### DETAILED DESCRIPTION

Embodiments of a social graph playlist service provide a user with a playlist of media assets determined from media assets recently played by friends of the user associated in a social graph. A service layer receives interaction data that identifies recently played media assets at user devices utilized by the friends of the user. A social graph playlist service can then generate a social graph playlist by determining a next media asset for the playlist from the recently played media assets. The service layer then communicates the next media asset for the playlist to be played at a user device that is associated with the user.

In addition, determining the next media asset for the playlist can include assigning a prediction rating to each of the recently played media assets that indicates a likelihood that the user will like each of the recently played media assets. A high prediction rating increases the likelihood that the social graph playlist service will select a recently played media asset as the next media asset for the playlist. The prediction rating can be based on stored interaction data that can include a compilation of interactions with media assets by the user. For example, if interaction data indicates that the user has downloaded and played many country songs, the social graph playlist service can determine that a user likes or may like a recently played country song and assign a high prediction rating to the media asset.

Alternatively or in addition, the prediction rating can be based on a user similarity rating determined from a similarity between stored interaction data associated with the user and stored interaction data associated with the friends of the user that are associated in the social graph. For example, a friend of a user may have a high user similarity rating if the friend has listened or downloaded many of the same songs that the user has also listened to and/or downloaded. Friends of the user that have a high user similarity rating may be more likely to play media assets that the user likes and/or may like. Therefore, the social graph playlist service can assign a high prediction rating to recently played media assets by friends with high user similarity ratings.

While features and concepts of the described systems and methods for a social graph playlist service can be implemented in any number of different environments, systems, and/or various configurations, embodiments of a social graph playlist service are described in the context of the following example systems and environments.

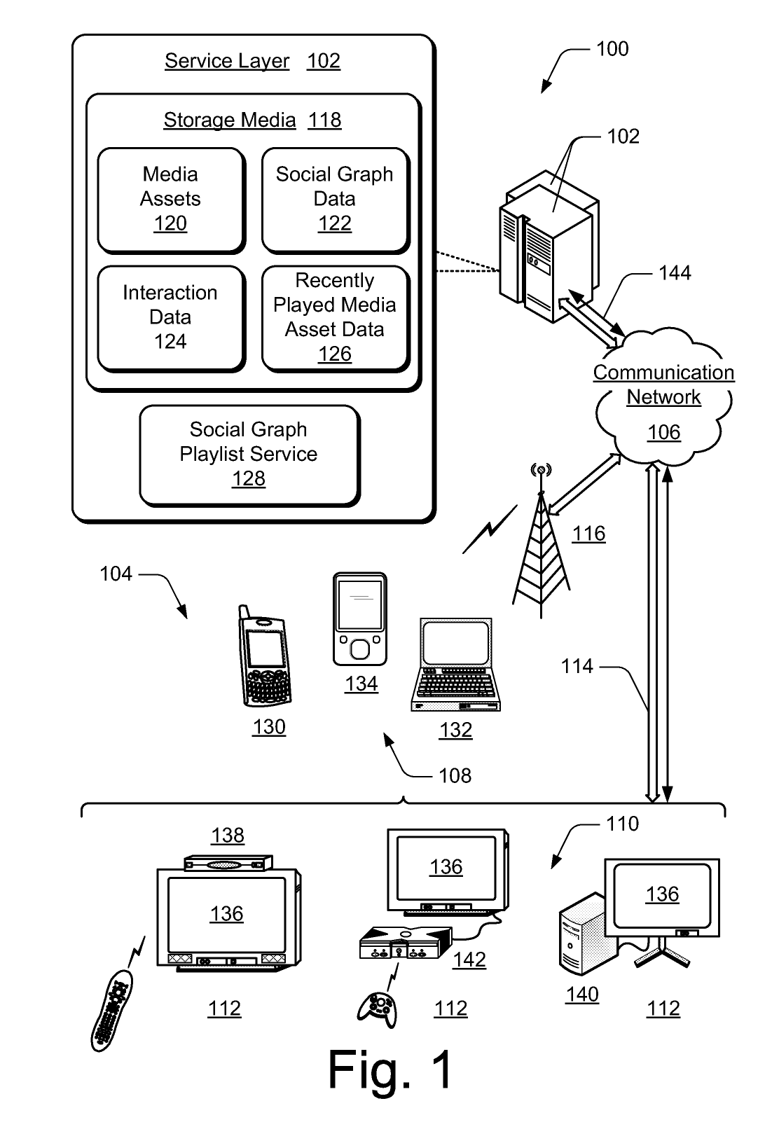

FIG. 1 illustrates an example system 100 in which various embodiments of a social graph playlist service can be implemented. In this example, system 100 includes a service layer 102 that can be configured to communicate or otherwise provide media assets and data to any number of various devices 104 via a communication network 106. The various devices 104 can include wireless devices 108 as well as other client devices 110 (e.g., wired and/or wireless devices) that are implemented as components in various client systems 112 in a media asset distribution system.

The communication network 106 can be implemented to include a broadcast network, an IP-based network 114, and/or a wireless network 116 that facilitates media asset distribution and data communication between the service layer 102 and any number of the various devices. The communication network 106 can also be implemented as part of a media asset distribution system using any type of network topology and/or communication protocol, and can be represented or otherwise implemented as a combination of two or more networks.

In the example system 100, service layer 102 includes storage media 118 to store or otherwise maintain various data and media assets, such as media assets 120, social graph data 122, interaction data 124, and recently played media asset data 126 that is a compilation of recently played media assets by friends of the user that are identified in a social graph. The storage media 118 can be implemented as any type of memory, random access memory (RAM), a nonvolatile memory such as flash memory, read only memory (ROM), and/or other suitable electronic data storage. Service layer 102 can also include one or more media content servers that are implemented to communicate, or otherwise distribute, the media assets 120 and/or other data to any number of the various user devices.

The media assets 120 can include any type of audio, video, and/or image data received from any type of media content or data source. As described throughout, media assets can include music, television programming, movies, on-demand media content, interactive games, network-based applications, and any other audio, video, and/or image data (e.g., to include program guide application data, user interface data, advertising content, closed captions data, content metadata, search results and/or recommendations, etc.).

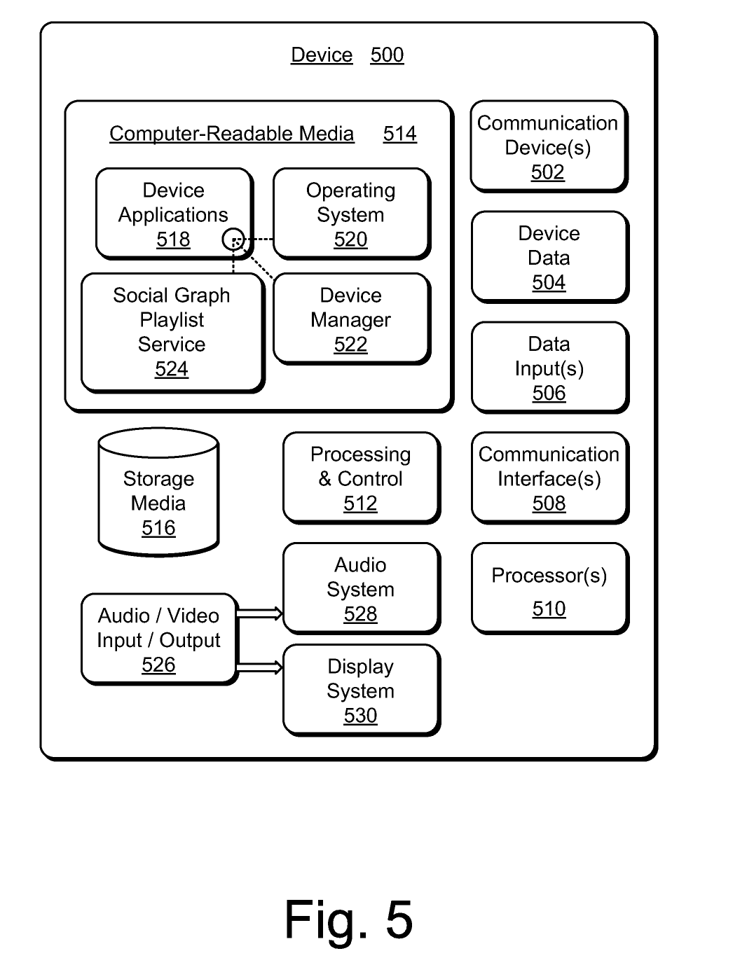

Service layer 102 also includes a social graph playlist service 128 that can be implemented as computer-executable instructions and executed by processors to implement the various embodiments and/or features described herein. In addition, service layer 102 can be implemented with any number and combination of differing components as further described with reference to the example device shown in FIG. 5. The social graph playlist service 128, as well as other functionality described to implement embodiments of a social graph playlist service, can also be provided as a service apart from the service layer 102 (e.g., on a separate server or by a third party service).

The wireless devices 108 can include any type of device implemented to receive and/or communicate wireless data, such as any one or combination of a mobile phone 130 (e.g., cellular, VoIP, WiFi, etc.), a portable computer device 132, a media device 134 (e.g., a personal media player, portable media player, etc.), and/or any other wireless device that can receive media assets in any form of audio, video, and/or image data. Each of the client systems 112 include a respective client device and display device 136 that together render or playback any form of audio, video, and/or image media content.

A display device 136 can be implemented as any type of a television, high definition television (HDTV), LCD, or similar display system. A client device in a client system 112 can be implemented as any one or combination of a television client device 138 (e.g., a television set-top box, a digital video recorder (DVR), etc.), a computer device 140, a gaming system 142, an appliance device, an electronic device, and/or as any other type of client device that may be implemented to receive media assets in any form of audio, video, and/or image data in a media asset distribution system.

Any of the various devices can be implemented with one or more processors, communication components, memory components, signal processing and control circuits, and a media asset rendering system. Further, any of the wireless devices 108 and/or other client devices 110 can be implemented with any number and combination of differing components as further described with reference to the example device shown in FIG. 5. A user device may also be associated with a user (i.e., a person) and/or an entity that operates the device such that a user device describes logical devices that include users, software, and/or a combination of devices.

Any of the wireless devices 108 and/or other client devices 110 can communicate with service layer 102 via a two-way data communication link 144 of the communication network 106. It is contemplated that any one or more of the arrowed communication link 144, IP-based network 114, and wireless network 116, along with communication network 106, facilitate two-way data communication, such as from a user device to the service layer 102 and vice-versa.

The service layer 102 can store the social graph data 122, the interaction data 124, and the recently played media asset data 126 when received from any of the user devices 104 via communication network 106. Social graph data 122 includes a list of friends of a user that are associated by social interactions, communications, and relational parameters that form a social graph. The social graph data 122 can include a list of persons known to the user, such as friends of the user, and the relationships between the user and the friends of the user. It is to be appreciated that friends of the user can include family members, coworkers, or any person that the user knows and is associated with in a social graph. In some embodiments, the social graph can be divided into smaller subsets such as a social graph for music friends of a user, family of a user, and/or coworkers of a user.

The interaction data 124 correlates to interactions with the media assets 120 by both the user and the friends of the user that are identified in the social graph and associated with the user. In various implementations, the interaction data can include, but is not limited to, catalog data, usage data, ratings data, and/or discussion data.

Catalog data includes a listing of available media assets 120. Catalog data may also include a listing of media assets that are downloaded, purchased, stored, and/or owned by a user or friends of the user. For example, a user may own a variety of different songs and videos that are stored on portable media device 134. In this example, a listing of the songs and videos stored on the portable media device can be communicated to the service layer 102 as catalog data. Further, when a new song or video is added to the portable media device, the catalog data associated with the new song or video can be received by service layer 102 to update the catalog data that is associated with the user.

Usage data indicates the number of times and/or frequency that a user or friends of the user have rendered or played media assets that are identified by the catalog data. For example the usage data can indicate that a particular song has been played hundreds of times on portable media device 134, or that movies starring a particular actor are frequently displayed for viewing at the portable media device. When a user or a friend of a user plays or renders a media asset, usage data can be received by the service layer 102 from the portable media device 134 via communication network 106.

In accordance with various embodiments, usage data includes recently played media asset data 126. The recently played media asset data 126 includes a list of recently played media assets at user devices 104 that are utilized by the friends of the user. For example, the service layer 102 can receive and maintain a list of the last five songs played by each friend of the user. It is to be appreciated, however, that the number of recently played media assets that are maintained in the list can vary (e.g., songs played today, songs played last week, or the last 100 songs played). Recently played media asset data 126 can also include currently playing media assets at user devices that are utilized by the friends of the user. It is to be appreciated, therefore, that the recently played media asset data 126 may be constantly updated to include currently playing media assets.

Ratings data includes ratings that have been assigned to media assets by a user or friends of the user. For example, a user can assign ratings to songs or movies on portable media device 134 to indicate how much the user likes a particular song or movie. When the user assigns a rating to a media asset, ratings data and/or updated ratings data can be received by the service layer 102 from the portable media device.

Discussion data includes discussions related to media assets by a user or friends of the user. Discussion data can be received from a variety of different sources, such as blogs and message boards. For example, a user can discuss a particular song on a message board associated with the song. When the user discusses a media asset, the discussion data can be received by the service layer 102 via communication network 106.

In various embodiments, the social graph playlist service 128 at service layer 102 is implemented to generate a social graph playlist that is associated with the user by determining a next media asset for the playlist from the recently played media asset data 126. After determining the next media asset for the playlist, the social graph playlist service 128 initiates communication of the next media asset for the playlist to be played at a user device 104 that is associated with the user.

To determine the next media asset for the playlist, the social graph playlist service 128 is implemented to determine which of the recently played media assets the user is likely or most likely to enjoy. A prediction rating that indicates a likelihood that the user will like the media asset can be determined and assigned to each of the recently played media assets. The social graph playlist service is also implemented to select a recently played media asset that has a high prediction rating. In at least some embodiments, the social graph playlist service selects a recently played media asset that has the highest prediction rating. The social graph playlist service can also prevent duplicative plays, and may not select a recently played media asset with the highest prediction rating if the media asset was played recently in the social graph playlist associated with the user.

In various embodiments, the social graph playlist service 128 assigns a prediction rating to each of the recently played media assets that indicates a likelihood that the user will like each media asset based on stored interaction data 124 associated with the user. As described above, service layer 102 can receive and store interaction data 124 from a user device that is associated with the user, such as catalog data, usage data, ratings data, and/or discussion data. The social graph playlist service can determine media assets that a user likes and/or may like based on the interaction data 124 that is associated with the user. For example, if catalog data and usage data associated with a user indicates that the user has downloaded and played many country songs, the social graph playlist service can determine that a user likes or may like a recently played country song and assign a high prediction rating to the media asset. The high prediction rating increases the likelihood that the social graph playlist service will select the media asset as the next media asset for the playlist.

In various embodiments, the social graph playlist service 128 assigns a prediction rating to each of the recently played media assets that indicates a likelihood that the user will like each media asset based on a user similarity rating. A user similarity rating is determined from a similarity between stored interaction data 124 associated with the user and stored interaction data 124 associated with the friends of the user that are associated in the social graph. For example, users that have similar catalog, usage, ratings, and/or discussion data can have a high user similarity rating (e.g., closer to 100%) whereas users whose catalog, usage, ratings, and/or discussion data has very little similarity have a low similarity rating (e.g., closer to 0%). For example, a friend of a user may have a high user similarity rating if the friend has listened or downloaded many of the same songs that the user has also listened to and/or downloaded. Friends of the user that have a high user similarity rating may be more likely to play media assets that the user likes and/or may like. Therefore, the social graph playlist service assigns a high prediction rating to recently played media assets by friends with high user similarity ratings. The high prediction rating increases the likelihood that the social graph playlist service will select the recently played media assets as the next media asset for the playlist.

In various embodiments, the service layer 102 is implemented to receive a rating of the next media asset from a user device associated with a user. For example, as described above, a user can assign ratings to songs or movies on portable media device 134 to indicate how much the user likes a particular song or movie. When the user assigns a rating to a media asset, the rating can be received by the service layer 102 from the portable media device and compiled as interaction data 124. This rating may subsequently be used when determining the next media asset for the playlist. For example, if the user assigns a high rating to the next media asset, and the next media asset is subsequently received as a recently played media asset, the social graph playlist service 128 may assign a high prediction rating to the media asset based on the rating that indicates that the user is likely to enjoy the media asset. In contrast, if the user assigns a low rating to the next media asset for the playlist, the social graph playlist service may assign a low prediction rating to the media asset and/or not select the media asset again.

In various embodiments, the service layer 102 is implemented to receive additional interaction data 124 that identifies currently playing media assets at the user devices that are utilized by the friends of the user. For example, when a friend of a user begins playing a new media asset, interaction data that identifies the new media asset as a currently playing media asset can be received by the service layer 102 from the portable media device 134 via communication network 106 and stored as recently played media asset data 126. It is to be appreciated, therefore, that the list of recently played media assets that can be selected for the social graph playlist is updated each time a new media asset is played by one of the friends of the user.

Continuously updating the list of recently played media assets enables the social graph playlist to stay current. For example, when a new song becomes popular, the new song may be added to the social graph playlist when a friend of the user plays the song. Additionally, continuously updating the list of recently played media assets enables the social graph playlist to play a variety of different media assets rather than playing the same media assets over and over. Increasing the number of friends in the social graph playlist may also increase the variety of different media assets that can be played because the number and variety of recently played media assets may increase.

The social graph playlist service 128 can also determine an additional next media asset for the playlist from the recently played media assets and the currently playing media assets. As described throughout, to determine the additional next media asset for the playlist, the social graph playlist service can determine which of the recently played and currently playing media assets the user is likely or most likely to enjoy. The social graph playlist service 128 then initiates communication of the additional next media asset for the playlist to be played at a user device 104 that is associated with the user.

Although illustrated and described as a component or module of the service layer 102, the social graph playlist service 128 can be implemented as an independent service to implement embodiments of a social graph playlist service. Further, although the social graph playlist service is illustrated and described as a single component or module, the social graph playlist service 128 can be implemented as several component applications or modules distributed to implement various embodiments of a social graph playlist service as described herein.

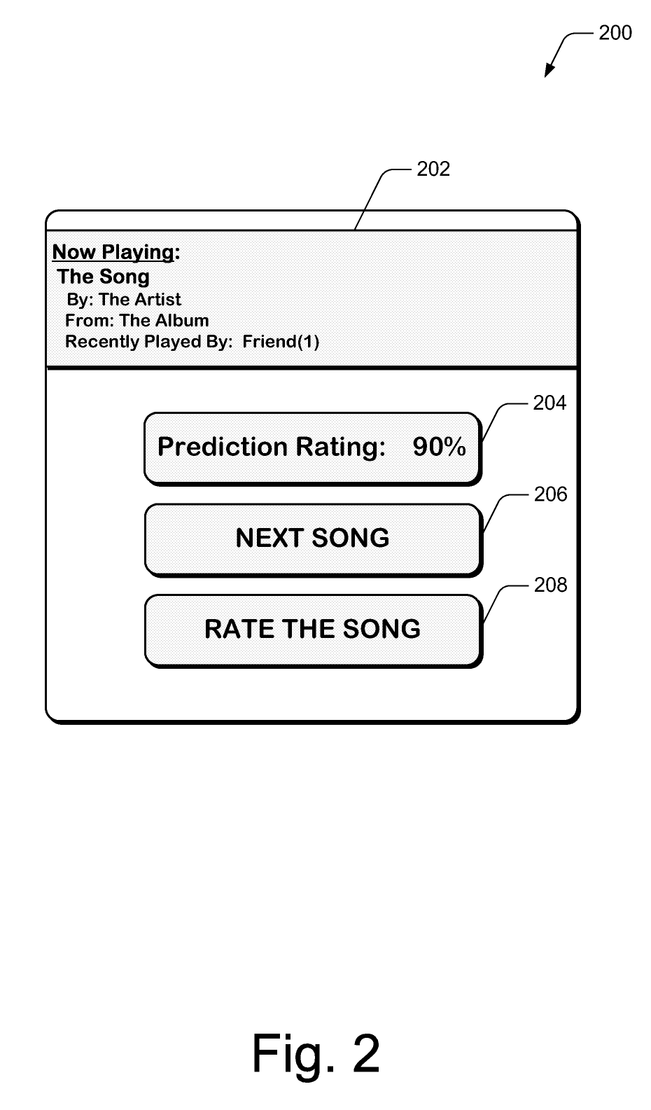

FIG. 2 illustrates an example social graph playlist interface 200 that indicates a next media asset being played as determined by the social graph playlist service 128 shown in FIG. 1, and received by a user device 104 to be played. Social graph playlist interface 200 includes a next media asset display 202, a prediction rating 204, media asset play control(s) 206, and a rating control 208.

The next media asset display 202 includes information about a media asset that is currently playing in the social graph playlist, such as the name of a song, the artist, and the friend that recently played the media song. As described above, the social graph playlist service 128 can determine a next media asset for the playlist from the recently played media assets and communicate the next media asset for the playlist to be played at a user device. In this example, the social graph playlist has determined and communicated The Song by The Artist from The Album for the playlist from the recently played media assets. As illustrated in FIG. 2, The Song was recently played by Friend(1) who is a friend of the user.

The prediction rating 204 indicates a likelihood that the user will like the media asset based at least in part on interaction data 124 and/or a user similarity rating. In this example, the social graph playlist service 128 has determined that the there is a 90% likelihood that the user will like the song. The user may be more inclined to continue listening to this song based on the high prediction rating that the user will like the song.

The media asset play control(s) 206 include various user-selectable controls to interact with the media asset, such as to play, rewind, fast-forward, render, download, purchase, rate, or discuss the media asset. It is to be appreciated, therefore, that the social graph playlist interface 200 can be integrated into a variety of different user interfaces, such as a media player user interface. In this example, media asset play control(s) 206 include a next song control that can be selected by the user to receive a next media asset to be played in the playlist. When the user selects the next song control, the selection is received at service layer 102. The social graph playlist service can then determine and communicate a next media asset for the playlist. The social graph playlist can communicate a next media asset for the playlist automatically when a media asset finishes playing, or is nearly finished playing.

When a user selects the next song control 206, that interaction data may also be communicated to service layer 102 to be stored as interaction data 124 associated with the user. More specifically, that interaction data can be communicated to service layer 102 to be compiled as ratings data. This interaction data may subsequently be used when determining the next media asset for the playlist. For example, if the user quickly selects the next song control when a media asset begins playing, this may indicate that the user does not enjoy the media asset. The social graph playlist service 128, therefore, may not select the media asset again based on this quick selection of the next control. Alternately, if the user selects a rewind or replay control after the media asset finishes playing, this may indicate that the user enjoys the media asset and cause the social graph playlist service 128 to select the media asset again.

The rating control 208 can be selected by the user to assign a rating to a media asset being played in the social graph playlist to indicate how much the user likes or dislikes the media asset. When the user assigns a rating to a media asset, the rating can be received by the service layer 102 from the portable media device and compiled as interaction data 124. This rating may subsequently be used when determining the next media asset for the playlist. For example, if the user assigns a high rating to the next media asset, and the next media asset is subsequently received as a recently played media asset, the social graph playlist service 128 may assign a higher prediction rating to the media asset based on the rating that indicates that the user is likely to enjoy the media asset. In contrast, if the user assigns a low rating to the next media asset for the playlist, the social graph playlist service may assign a low prediction rating to the media asset and/or not select the media asset again.

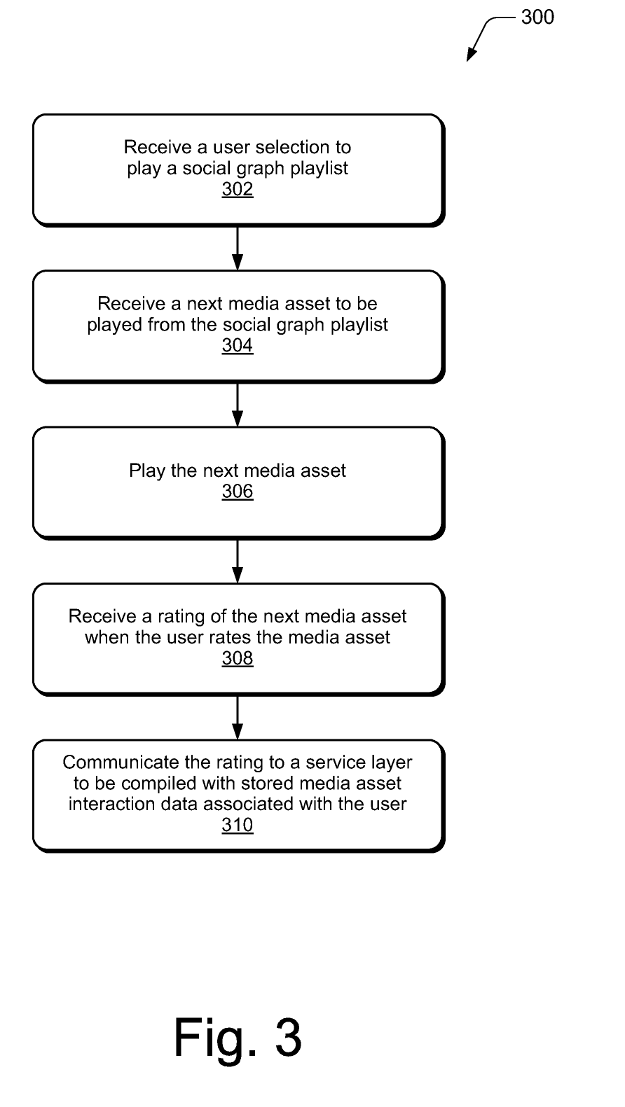

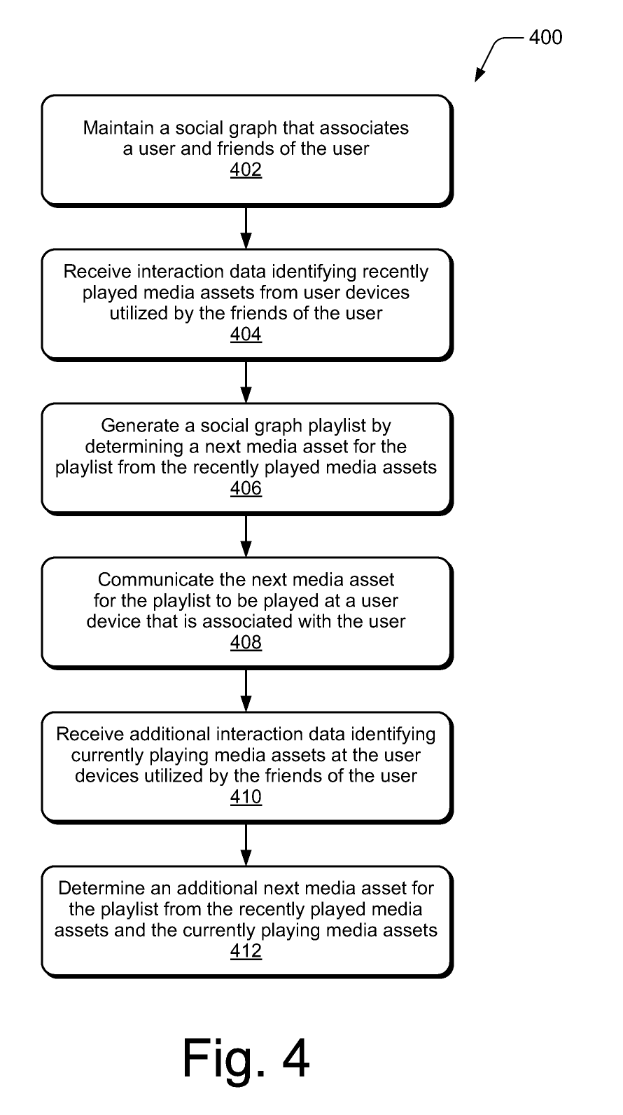

Example methods 300 and 400 are described with reference to respective FIGS. 3 and 4 in accordance with one or more embodiments of a social graph playlist service. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example methods may be described in the general context of computer-executable instructions, which can include software, applications, routines, programs, objects, components, data structures, procedures, modules, functions, and the like.

The methods may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of a social graph playlist service. The order in which the method is described is not intended to be construed as a limitation, and any number of the described method blocks can be combined in any order to implement the method, or an alternate method.

At block 302, a user selection to play a social graph playlist is received. For example, a user device 104 (FIG. 1) receives a user selection to play a social graph playlist that includes recently played media assets by friends of the user. The recently played media assets can include a digital music file of a song, a digital video file of a video, or any other type of media asset as described throughout.

At block 304, a next media asset to be played from the social graph playlist is received. For example, the user device 104 receives a next media asset to be played from the service layer 102 when generated by the social graph playlist service. At block 306, the next media asset is played. For example, social graph playlist interface 200 indicates a next media asset that is being played at a user device.

At block 308, a rating of the next media asset is received when the user rates the media asset. For example, user device 104 receives a rating of the next media asset when a user optionally selects rating control 208. At block 310, the rating is communicated to a service layer to be compiled with stored interaction data associated with the user. For example, user device 104 communicates the rating to service layer 102 to be compiled as interaction data 124.

FIG. 4 illustrates example method(s) 400 of a social graph playlist service. The order in which the method is described is not intended to be construed as a limitation, and any number of the described method blocks can be combined in any order to implement the method, or an alternate method.

At block 402, a social graph that associates a user and friends of the user is maintained. For example, social graph data 122 is maintained at service layer 102. At block 404, interaction data identifying recently played media assets is received from user devices utilized by the friends of the user. For example, the service layer 102 (FIG. 1) receives interaction data 124 identifying recently played media assets from user devices 104 that are associated with friends of a user.

At block 406, a social graph playlist is generated by determining a next media asset for the playlist from the recently played media assets. For example, the social graph playlist service 128 at the service layer 102 determines a next media asset for the playlist from the recently played media asset data 126. In various embodiments, the next media asset for the playlist is determined by assigning a prediction rating to each of the recently played media assets that indicates a likelihood that the user will like each of the recently played media assets. The prediction rating can be based on stored interaction data 124 associated with the user. The interaction data 124 can include catalog data, usage data, ratings data, and/or discussion data. Alternatively or in addition, the prediction rating can be based on a user similarity rating determined from a similarity between stored interaction data associated with the user and stored interaction data associated with the friends of the user that are associated in the social graph.

At block 408, the next media asset for the playlist is communicated to be played at a user device that is associated with the user. For example, the service layer 102 communicates the next media asset to be played in social graph playlist interface 200 at the user device 104.

At block 410, additional interaction data identifying currently playing media assets at the user device utilized by the friends of the user is received. For example, a portable media device 134 utilized by a friend of the user begins playing a new media asset. Interaction data that identifies the new media asset as a currently playing media asset is received by the service layer 102 from the portable media device 134 via communication network 106 and stored as recently played media asset data 126. At block 412, an additional media asset for the playlist is determined from the recently played media assets and the currently playing media assets. For example, the social graph playlist service 128 at the service layer 102 determines an additional next media asset for the playlist from the recently played media asset data 126 and the currently playing media assets. The social graph playlist service 128 then initiates communication of the additional next media asset for the playlist to be played at a user device 104 that is associated with the user.

FIG. 5 illustrates various components of an example device 500 that can be implemented as any type of client device and/or service layer as described with reference to FIG. 1 to implement embodiments of a social graph playlist service. In embodiments, device 500 can be implemented as any one or combination of a wired and/or wireless device, as any form of television client device (e.g., television set-top box, digital video recorder (DVR), etc.), consumer device, computer device, portable computer device, user device, communication device, video processing and/or rendering device, appliance device, gaming device, electronic device, and/or as any other type of device. Device 500 may also be associated with a user (i.e., a person) and/or an entity that operates the device such that a device describes logical devices that include users, software, firmware, and/or a combination of devices.

Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content source and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices can communicate data with device 500.

Device 500 can include one or more processors 510 (e.g., any of microprocessors, controllers, and the like) which process various computer-executable instructions to control the operation of device 500 and to implement embodiments of a social graph playlist service. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 can also include computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager 522 (e.g., a control application, software application, signal processing and control module, code that is native to a particular device, a hardware abstraction layer for a particular device, etc.). The device applications 518 can also include any system components or modules of a social graph playlist service 524 to implement the various embodiments described herein. In this example, the device applications 518 are shown as software modules and/or computer applications. Alternatively or in addition, the social graph playlist service 524 can be implemented as hardware, software, firmware, or any combination thereof.

Device 500 can also include an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, audio system 528 and/or the display system 530 can be implemented as external components to device 500. Alternatively, the audio system 528 and/or the display system 530 can be implemented as integrated components of example device 500.

Although embodiments of a social graph playlist service have been described in language specific to features and/or methods, it is to be understood that the subject of the appended claims is not necessarily limited to the specific features or methods described. Rather, the specific features and methods are disclosed as example implementations of a social graph playlist service.

1. A computer-implemented method initiated at a user device, the method comprising:
receiving a user selection to play a social graph playlist that includes recently played media assets by friends of a user that are associated in a social graph;
receiving a next media asset to be played from the social graph playlist, the next media asset being selected from the recently played media assets by the friends of the user; and
playing the next media asset at the user device.

2. The computer-implemented method as recited in claim 1, wherein the recently played media assets include media assets currently being played by the friends of the user.

3. The computer-implemented method as recited in claim 1, wherein the next media asset to be played is selected from the recently played media assets based on a prediction rating that indicates a likelihood that the user will like each of the recently played media assets, the prediction rating based at least in part on stored interaction data associated with the user.

4. The computer-implemented method as recited in claim 1, wherein the next media asset to be played is selected from the recently played media assets based on a prediction rating that indicates a likelihood that the user will like each of the recently played media assets, the prediction rating based at least in part on a user similarity rating determined from a similarity between stored interaction data associated with the user and stored interaction data associated with the friends of the user that are associated in the social graph.

5. The computer-implemented method as recited in claim 1, further comprising:
receiving a rating of the next media asset when the user rates the media asset; and
communicating the rating to a service layer to be compiled with stored interaction data associated with the user.

6. The computer-implemented method as recited in claim 1, wherein the recently played media assets are digital music files of songs.

7. A computer-implemented method, comprising:
maintaining a social graph that associates a user and friends of the user, the social graph based at least on parameters that define a social relationship between the user and the friends of the user;
receiving interaction data from user devices that are utilized by the friends of the user, the interaction data identifying recently played media assets at the user devices that are utilized by the friends of the user;
generating a social graph playlist that is associated with the user by determining a next media asset for the social graph playlist from the recently played media assets; and
communicating the next media asset for the social graph playlist to be played at a user device that is associated with the user.

8. The computer-implemented method as recited in claim 7, wherein the next media asset for the social graph playlist is determined by assigning a prediction rating to each of the recently played media assets that indicates a likelihood that the user will like each media asset, the prediction rating based at least in part on stored interaction data associated with the user.

9. The computer-implemented method as recited in claim 7, wherein the next media asset for the social graph playlist is determined by assigning a prediction rating to each of the recently played media assets that indicates a likelihood that the user will like each of the recently played media assets, the prediction rating based at least in part on a user similarity rating determined from a similarity between stored interaction data associated with the user and stored interaction data associated with the friends of the user that are associated in the social graph.

10. The computer-implemented method as recited in claim 7, further comprising:
receiving a rating of the next media asset from the user device associated with the user; and
compiling the rating with stored interaction data associated with the user.

11. The computer-implemented method as recited in claim 7, further comprising receiving additional interaction data from the user devices that are utilized by the friends of the user, the additional interaction data identifying currently playing media assets at the user devices that are utilized by the friends of the user.

12. The computer-implemented method as recited in claim 11, further comprising determining an additional next media asset for the social graph playlist associated with the user from the recently played media assets and the currently playing media assets.

13. The computer-implemented method as recited in claim 7, wherein the recently played media assets are digital music files of songs.

14. A playlist system, comprising:
a social graph that associates a user and friends of the user, the social graph based at least on parameters that define a social relationship between the user and the friends of the user;
at least a memory and a processor configured to implement a social graph playlist service configured to:
receive interaction data from user devices that are utilized by the friends of the user, the interaction data identifying recently played media assets at the user devices that are utilized by the friends of the user;
generate a social graph playlist that is associated with the user by determining a next media asset for the social graph playlist from the recently played media assets; and
initiate communication of the next media asset for the social graph playlist to be played at a user device that is associated with the user.

15. The playlist system as recited in claim 14, wherein the social graph playlist service is configured to determine the next media asset for the social graph playlist by assigning a prediction rating to each of the recently played media assets that indicates a likelihood that the user will like each media asset, the prediction rating based at least in part on stored interaction data associated with the user.

16. The playlist system as recited in claim 14, wherein the social graph playlist service is configured to determine the next media asset for the social graph playlist by assigning a prediction rating to each of the recently played media assets that indicates a likelihood that the user will like each of the recently played media assets, the prediction rating based at least in part on a user similarity rating determined from a similarity between stored interaction data associated with the user and stored interaction data associated with the friends of the user that are associated in the social graph.

17. The playlist system as recited in claim 14, wherein the social graph playlist service is further configured to:
receive a rating of the next media asset from the user device associated with the user; and
compile the rating with stored interaction data associated with the user.

18. The playlist system as recited in claim 14, wherein the social graph playlist service is further configured to receive additional interaction data from the user devices that are utilized by the friends of the user, the additional interaction data identifying currently playing media assets at the user devices that are utilized by the friends of the user.

19. The playlist system as recited in claim 18, wherein the social graph playlist service is further configured to determine an additional next media asset for the social graph playlist from the recently played media assets and the currently playing media assets.

20. The playlist system as recited in claim 14, wherein the recently played media assets are digital music files of songs.
